(19) United States
(12) Patent Application Publication
(10) Pub. No.: US 2010/0162891 A1
(43) Pub. Date: Jul. 1, 2010

(54) VAPOR-LIQUID CONTACTING IN CO-CURRENT CONTACTING APPARATUSES

(76) Inventors: Zhanping XU, East Amherst, NY (US); Dennis Bielinski, Lockport, NY (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/347,030

(22) Filed: Dec. 31, 2008

(51) Int. Cl. B01D 19/00

(52) U.S. Cl. 95/262; 261/114.1; 261/94

(57) ABSTRACT

Improved contacting modules and apparatuses containing the modules, for carrying out vapor-liquid contacting, are described. In representative contacting modules, liquid (and possibly vapor) are discharged into co-current flow channels in a non-uniform manner (e.g., from only one side of the channels). Particular contacting modules comprise at least one liquid downcomer and a demister, wherein the liquid downcomer and an inlet surface of the demister define a co-current flow channel and wherein liquid is discharged from an outlet of the downcomer. The use of one or more added liquid distribution devices to more uniformly distribute the discharged liquid improves vapor-liquid contacting efficiency in the co-current flow channel and consequently vapor-liquid mass transfer and approach to equilibrium for the contacting stage.

### FIELD OF THE INVENTION

The invention relates to contacting apparatuses for performing vapor-liquid contacting such as in fractional distillation or other mass and/or heat transfer operations. The invention more specifically relates to contacting modules used to provide high capacity, high efficiency co-current vapor-liquid contacting.

### DESCRIPTION OF RELATED ART

Vapor-liquid contacting devices, such as fractionation trays and packings, are employed to perform a wide variety of separations, particularly in the petroleum and petrochemical industries. Fractionation trays, for example, are used separating hydrocarbons into fractions having a similar relative volatility or boiling point. These fractions include crude oil-derived products of petroleum refining and petrochemical processing, such as naphtha, diesel fuel, LPG, and polymers. In some cases, trays are used to separate specific compounds from others of the same chemical or functional class, for example alcohols, ethers, alkylaromatics, monomers, solvents, inorganic compounds, etc. Trays are also used in gas processing and absorptive separation operations. A wide variety of trays and other contacting devices having differing advantages and drawbacks have been developed.

Fractionation trays and packings are the predominant forms of conventional vapor-liquid contacting devices used in distillation apparatuses, for example, in the applications described above. In the case of trays, a typical fractionation column will utilize about 10 to 250 of these contacting devices, depending on the ease of the separation (relative volatility difference) and desired product purity. Often the structure of each tray in the column is similar, but it is also known that the structures may differ (e.g., alternate) with respect to vertically adjacent trays. Trays are mounted horizontally, normally at a uniform vertical distance referred to as the tray spacing of the column. This distance may, however, vary in different sections of the column. The trays are often supported by rings welded to the inner surface of the column wall.

Fractional distillation has traditionally been conducted in cross flow or counter current contacting devices having an overall downward liquid flow and upward vapor flow. At some point in the apparatus the vapor and liquid phases are brought into contact to allow the vapor and liquid phases to exchange components and achieve, or approach as closely as possible, vapor-liquid equilibrium with each other. The vapor and liquid are then separated, moved in their respective directions, and contacted again with another quantity of the appropriate fluid at a different stage. In many conventional vapor-liquid contacting devices, vapor and liquid are contacted in a cross flow arrangement at each stage. An alternative apparatus differs from traditional multi-stage contacting systems in that while the overall flow in the apparatus continues to be countercurrent, each stage of actual contacting between the liquid and vapor phases is at least partially performed in a co-current mass transfer zone.

During fractional distillation processes using conventional trays, vapor generated at the bottom of the column rises through a large number of small perforations spread over the decking area of the tray, which supports a quantity of liquid. The passage of the vapor through the liquid generates a layer of bubbles referred to as froth. The high surface area of the froth helps to establish a compositional equilibrium between the vapor and liquid phases on the tray. The froth is then allowed to separate into vapor and liquid. During vapor-liquid contacting, the vapor loses less volatile material to the liquid and thus becomes slightly more volatile as it passes upward through each tray. Simultaneously the concentration of less volatile compounds in the liquid increases as the liquid moves downward from tray to tray. The liquid separates from the froth and travels downward to the next lower tray. This continuous froth formation and vapor-liquid separation is performed on each tray. Vapor-liquid contacting devices therefore perform the two functions of contacting the rising vapor with liquid and then allowing the two phases to separate and flow in different directions. When the steps are performed a suitable number of times on different trays, multiple equilibrium stages of separation can be achieved, leading to the effective separation of chemical compounds based upon their relative volatility.

Many different types of vapor-liquid contacting devices including packings and trays have been developed in an effort improve such separations. Different devices tend to have different advantages. For instance, multiple downcomer trays have high vapor and liquid capacities and the ability to function effectively over a significant range of operating rates. Structured packings tends to have a low pressure drop, making them useful in low pressure or vacuum operations. Perforated decks are efficient contacting devices, but can cause high pressure drop in a column, especially when used in a relatively small deck area, even if the fractional open area is high. Two important parameters used to evaluate the performance of any vapor-liquid contacting device are capacity and efficiency. Both of these, however, may be compromised if maldistribution of liquid or vapor occurs in a vapor-liquid contacting apparatus. Maldistribution of liquid or vapor has a tendency to propagate from one stage to the next, reducing the capacity and efficiency of the apparatus as a whole.

Particular examples of known vapor-liquid contacting devices include, for example, those described in U.S. Pat. No. 6,682,633 for co-current contacting of vapor and liquid in a number of structural units which are placed in horizontal layers. U.S. Pat. No. 5,837,105 and related U.S. Pat. No. 6,059,934 disclose a fractionation tray having multiple co-current contacting sections spread across the tray.

Other devices and apparatuses incorporating these devices, which address the issues discussed above and other considerations, are described in U.S. Pat. No. 7,424,999, hereby incorporated by reference. These devices are contacting modules in horizontal stages and differ from a conventional tray-like construction. The modules of one stage are rotated to be non-parallel with respect to the modules of an inferior stage, a superior stage, or both. The contacting modules include at least a liquid distributor (liquid downcomer) and a demister (vapor-liquid separator) which together define a contacting volume, namely a co-current flow channel. Ascending vapor enters the contacting volume and entrains liquid that is discharged from the liquid distributor. The ascending vapor and entrained liquid are carried co-currently in the contacting volume to the demister, which partitions or separates the vapor and liquid such that these streams can separately flow upward and downward, respectively, after contact. Liquid exiting the demister flows onto a receiving pan and is then directed downward through a duct. Each of the ducts associated with a single receiving pan direct the liquid into a separate liquid downcomer of an inferior contacting stage. Vapor exiting the demister flows to a fluid transfer volume above the receiving pan and then into the contacting volume of a superior contacting stage.

Improvements in devices such as these and others, especially with respect to improving their capacity and efficiency, as well as overcoming various disadvantages associated with sub-optimal distribution, are continually being sought.

### SUMMARY OF THE INVENTION

The present invention is associated with the discovery of improved contacting modules for carrying out vapor-liquid contacting, and especially in co-current contacting modules where liquid and/or vapor are discharged into co-current flow channels in a non-uniform manner (e.g., from only one side of the channels). The invention applies, for example, to co-current vapor-liquid contacting devices with non-parallel stages and structures for transferring liquid from one stage to the next inferior stage without reducing liquid handling capability. Such devices provide an efficient usage of column space for fluid flow and contacting, in order to achieve high capacity, high efficiency, and low pressure drop. The use of one or more added liquid distribution devices to optimize liquid distribution and vapor-liquid contacting, especially in the contacting volume or co-current flow channel where liquid is first introduced in a non-uniform manner, further improves efficiency.

Aspects of the invention pertain particularly to contacting devices in which liquid is introduced or discharged into co-current flow channels from the outlet of a liquid distributor or downcomer extending between these flow channels. The use of a liquid distribution device extending horizontally within or near the co-current flow channels (e.g., near the outlet of the liquid downcomer) effectively improves the fluid flow distribution across the co-current flow channel, leading to improved contacting and mass transfer efficiency.

Embodiments of the invention therefore relate to high capacity and high efficiency co-current vapor-liquid contacting apparatuses for use in fractionation columns and other vapor-liquid contacting processes. According to one embodiment, the apparatus comprises a plurality of stages having at least one contacting module comprising (i) at least one liquid downcomer having an outlet proximate at least one co-current flow channel, (ii) a demister having an inlet surface proximate the co-current flow channel and an outlet surface superior to a receiving pan, and (iii) at least one duct having an upper end in fluid communication with the receiving pan, and a lower end. The lower end of each duct is in fluid communication with a separate liquid downcomer of an inferior stage. Advantageously, the contacting module also comprises a liquid distribution device proximate the outlet of the liquid downcomer, in order to improve liquid, and possibly also vapor, distribution in the co-current flow channel and thereby further benefit the contacting module and vapor-liquid contacting apparatus in terms of its separation efficiency. In the apparatus, the contacting module is rotated with respect to a contacting module immediately above and/or below, meaning a module of a superior or inferior stage, respectively, of the plurality of stages.

In another embodiment, the apparatus for performing co-current vapor-liquid contacting comprises a plurality of stages having at least one contacting module and a plurality (i.e., two or more) receiving pans. The contacting module comprises (i) at least one pair of substantially parallel demisters being spaced apart, (ii) a liquid downcomer located between the demisters and defining, with inlet surfaces of the demisters, a pair of co-current flow channels, characterized in that (a) the inlet surfaces of the demisters are in fluid communication with the co-current flow channels, (b) the liquid downcomer has an outlet in fluid communication with the co-current flow channels, and (c) the demisters have outlet surfaces superior to (or above) separate receiving pans of the plurality of receiving pans. The contacting module additionally comprises a liquid distribution device extending across vapor inlets of the pair of co-current flow channels. According to this embodiment, each receiving pan has at least one duct, with each duct of any one receiving pan providing fluid communication to a separate liquid downcomer of an inferior stage. Also, the contacting module is in non-parallel alignment with respect to the contacting module of an inferior stage of the plurality of stages.

Representative contacting stages according to these embodiments comprise at least module (e.g., 2, 3, 4, 5, 6, 7, 8, 9, or 10 modules), each having a liquid downcomer associated with two demisters. Representative contacting stages have modules in a parallel, alternative arrangement with receiving pans, where the number of receiving pans in a stage will generally exceed the number of downcomers by one, due to the placement of terminal receiving pans on both ends of each stage.

Other embodiments of the invention relate to contacting modules comprising at least one liquid downcomer and a demister, wherein the liquid downcomer and an inlet surface of the demister define a co-current flow channel and wherein liquid discharged from an outlet of the downcomer enters the co-current flow channel non-uniformly (e.g., from one side of the co-current flow channel). In other words, the outlet of the downcomer therefore communicates non-uniformly with the co-current flow channel. Advantageously, the contacting module further comprises a liquid distribution device proximate an outlet of the liquid downcomer to more uniformly distribute liquid entering the co-current flow channel, especially across a horizontal cross section that is traversed by entraining vapor that enters the co-current flow channel in an upflowing direction. Particular contacting modules comprise at least one liquid downcomer having an outlet proximate one side of the co-current flow channel and a demister having an inlet surface proximate the opposite side of co-current flow channel. The modules may additionally comprise an outlet surface superior to a receiving pan. The contacting module may also include at least one duct having an upper end in fluid communication with the receiving pan, and a lower end. The contacting module is adapted to be rotated with respect to a second contacting module of an inferior stage of the apparatus in which the modules are used for performing co-current vapor-liquid contacting, whereby the lower end of each duct can be positioned in fluid communication with a separate liquid downcomer of the inferior stage.

Further embodiments of the invention relate to methods for contacting vapor and liquid streams comprising passing the streams through a co-current flow channel in a contacting module, or in an apparatus comprising a contacting module, as described herein.

As discussed above, an important aspect of the contacting modules, and apparatuses containing these modules, is the use of a liquid distribution device at or near the outlet of one or more the liquid downcomers of the contacting module. These devices effectively reduce flow non-uniformities and particularly the variances in the vapor:liquid ratio from one side of the co-current flow channel, at the liquid outlet of the downcomer, to the opposite side, at the inlet surface of a demister. The liquid distribution devices are therefore generally located and positioned horizontally near the outlet of the liquid downcomer (i.e., near the vapor inlets to the each of the pair of co-current flow channels between which the downcomer extends). According to one embodiment, therefore, the liquid distribution device extends across the vapor inlet to one or preferably both of the pair of co-current flow channels. The distribution device may therefore be positioned in the contacting module of the same stage as the liquid downcomer and co-current flow channels. Alternatively, the device may be positioned in the liquid inlet of a different but vertically aligned downcomer of an immediately inferior stage, for example with the device extending across an area or portion of this liquid inlet that is not engaged or traversed by lower ends of ducts from the contacting module of the stage immediately above.

Regardless of the position or location of the liquid distribution device, various configurations are possible, which preferably do not significantly reduce the cross-sectional surface area of the inlet of the co-current flow channel through which vapor flows in the upward direction in order to contact and entrain liquid exiting the downcomer. The liquid distribution device may be directly in liquid communication with the outlet of the liquid downcomer, for example, if the downcomer outlet feeds directly into a partially or substantially enclosed volume of the liquid distribution device and is directed to a plurality of openings in the form of conduits (e.g., having a cylindrical shape), through which the liquid exits and becomes entrained into the co-current flow channel by vapor flowing upwardly through the openings. The liquid distribution device, which in some cases receives liquid from the downcomer outlet, may alternatively be open at the top, for example, in the form a trough that is open at an upper perimeter. This upper perimeter can have one or a plurality of notches (i.e., a notched edge) to better distribute any liquid that might overflow the trough. In such an embodiment, a plurality of openings can be located in a lower base of the trough to provide the main or all sources of normally exiting liquid for contact with, and entrainment by, the upwardly flowing vapor.

According to other embodiments, the liquid distribution device may be in the form of a plate having a plurality of openings (e.g., slotted), preferably with a portion of openings being directed toward the demister and particularly its inlet surface, in order to promote the entrainment of liquid discharged from the downcomer outlet into regions of the co-current flow channel that would otherwise (i.e., without the distribution device) have a relatively high vapor:liquid ratio, compared to the region near this downcomer outlet. Slotted openings that direct upwardly flowing vapor to one side or opposite sides of the co-current channel may be combined, in the slotted plate configuration, with other types of openings such as sieve holes, valves, bubble caps, etc.

In any of the above specific types of liquid distribution devices and other types, the openings or conduits may have a number of possible cross-sectional shapes, including a line (in the case of slotted openings), circle, oval, rectangle (e.g., square), or polygon. Also, in some cases it may be desirable to pack the interior of one or more co-current flow channels with a suitable packing material to improve uniformity of the vapor:liquid ratio throughout. Packing may therefore itself be the liquid distribution device used to improve vapor and liquid flow uniformity within the co-current flow channel. Suitable packing can include porous materials and/or structured materials (e.g., raschig rings) known in the art for improving contacting by providing an enhanced surface area. Combinations of any of the devices discussed above may be used. For example, a slotted plate near the outlet of a liquid downcomer that encloses the vapor inlet of the associated co-current flow channel may be combined with a packing in the channel itself. Otherwise, a slotted plate construction may be combined, for example, with devices as described above and illustrated elsewhere, for example those having conduits.

These and other embodiments relating to the present invention are apparent from the following Detailed Description.

### BRIEF DESCRIPTION OF THE DRAWINGS

FIG. 1 is a cross-sectional schematic of a representative apparatus comprising contacting stages with contacting modules.

FIG. 2 is a cross-sectional schematic of a representative individual contacting module.

FIG. 3 is a top view of an individual contacting stage.

FIG. 4 is another cross-sectional schematic of an apparatus, depicting three stages of contacting modules.

FIG. 5 depicts both liquid and vapor flows through a co-current flow channel.

FIG. 6 depicts a contacting module having a slotted plate as a liquid distribution device.

FIG. 6a is a top view of the slotted plate of FIG. 6.

FIG. 7 depicts a contacting module having a liquid distribution device that is engaged by a liquid downcomer outlet.

FIGS. 7a and 7b are top and end views, respectively, of the device of FIG. 7.

FIG. 8 depicts a contacting module having a trough as a liquid distribution device.

FIG. 8a is an end view of the liquid distribution device of FIG. 8.

The same reference numbers are used to illustrate the same or similar features throughout the drawings. The drawings are to be understood to present an illustration of the invention and/or principles involved. As is readily apparent to one of skill in the art having knowledge of the present disclosure, apparatuses, contacting modules, or liquid distribution devices according to various other embodiments of the invention will have configurations and components determined, in part, by their specific use.

### DETAILED DESCRIPTION

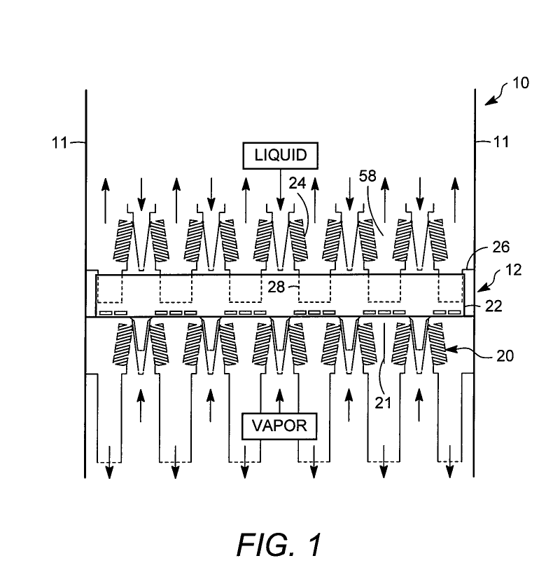

FIG. 1 illustrates a co-current vapor-liquid contacting apparatus according to the present invention, comprising stages within a vessel 10. The vessel 10 may be for example a distillation column, absorber, direct contact heat exchanger, or other vessel used to conduct vapor-liquid contacting. The vessel 10 contains contacting stages 12 and optional collector/distributors. A fractionation or distillation column typically contains from about 10 to about 250 or more contacting stages 12. The design of contacting modules 20 of these stages may be essentially uniform throughout the column, but it may also vary, for example, to accommodate changes in fluid flow rates in different parts of the column. For simplicity, only three contacting stages are shown in FIG. 1.

It is understood that an apparatus such as a distillation column may contain several sections, with each section having numerous contacting stages. Also, there may be a plurality of fluid feed introductions and/or fluid product withdrawals between and/or within sections. Conventional contacting devices (e.g., trays and/or packings) used in distillation may be mixed in the same and/or different sections of the apparatus (e.g., above and/or below), as the sections having contacting stages described herein. The vessel 10 includes an outer shell 11 that typically has a cylindrical cross section.

According to FIG. 1 each contacting stage 12 has a 90° rotation with respect to the directly superior and inferior stages, thereby distributing liquid in a direction that is orthogonal to the immediately superior stage to reduce liquid maldistribution. In other embodiments, vertically adjacent contacting stages may be oriented with different degrees of rotation that may be the same from stage to stage or may vary. Each contacting stage 12 comprises a plurality of contacting modules 20 and receiving pans 26.

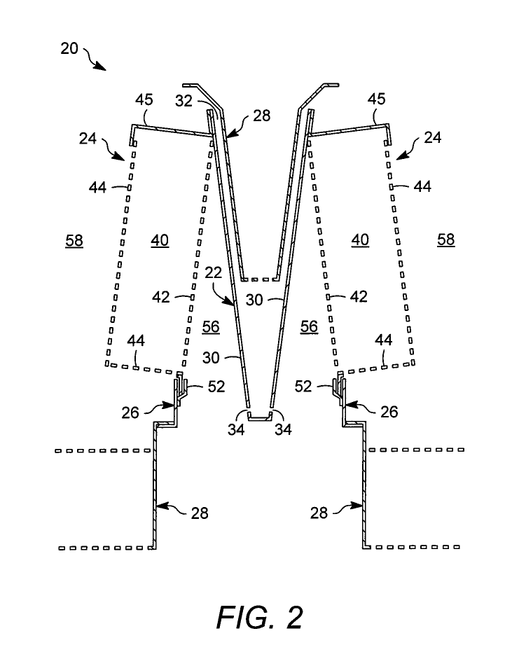

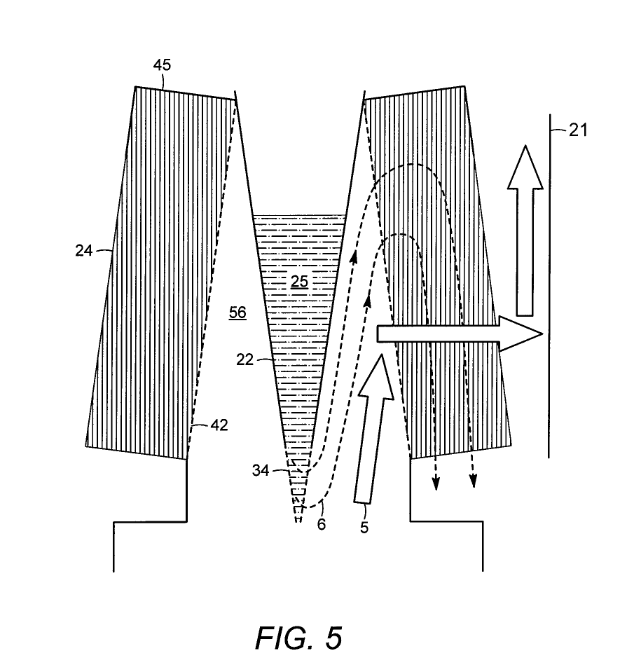

As shown in FIGS. 2 and 5, contacting modules 20 may include a liquid distributor or liquid downcomer 22 located between a pair of vapor-liquid separators or demisters 24. The liquid downcomer 22 and demisters 24 cooperate to define the co-current fluid contacting volume or co-current flow channel 56. In addition to the contacting modules 20, each stage also includes a plurality of receiving pans 26, with each receiving pan 26 having a plurality of ducts 28. An inlet 32 to the liquid downcomer 22 is configured to engage the ducts 28 of a receiving pan of the immediately superior contacting stage.

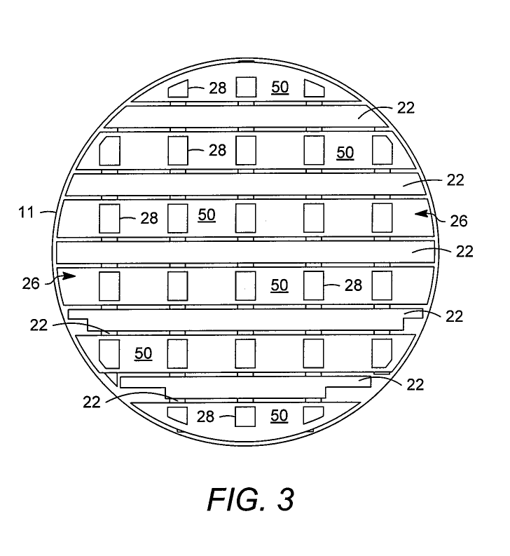

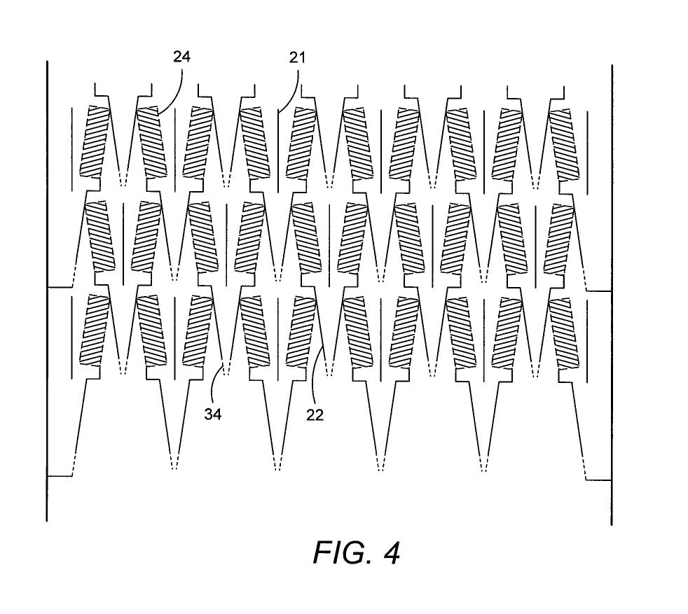

FIG. 3 illustrates a top view of two adjacent (inferior and superior) stages in which the demisters are not shown to more clearly show the arrangement of receiving pans 26, ducts 28, and liquid downcomers 22. At each stage, the receiving pans 26 are substantially parallel and are spaced apart across the cross sectional area of the apparatus or vessel. The liquid downcomer 22 of a contacting module 20 is located between each pair of adjacent receiving pans 26 of the same contacting stage, resulting in an alternating pattern of receiving pans 26 and modules 20. Liquid downcomers 22 and the receiving pans 26 at each stage may be supported by support rings (not shown) affixed to the inner surface of the vessel wall or outer shell 11 by welding or other conventional means. The liquid downcomers 22 and their associated receiving pans 26 may be bolted, clamped, or otherwise secured to the support ring to maintain them in a desired position or column height during operation and to prevent fluid leakage across the stages, outside of desired contacting areas.

Receiving pans located between two contacting modules, and those located between a module and the vessel shell or outer wall, are referred to as central and terminal receiving pans, respectively. Central receiving pans are thus shared by two adjacent contacting modules. In another embodiment (not illustrated) a pair of receiving pans is incorporated into each contacting module. When such modules are arranged in a substantially parallel alignment across the stage, the modules are adjacent such that there are two receiving pans between each pair of adjacent liquid downcomers. A vertical baffle 21 is optionally included between two adjacent contacting modules 20 in order to intercept vapor emanating from the demisters 24 and, in general, to reduce any tendency of the emerging fluids to interfere with each other in a fluid transfer volume 58 above receiving pans 26. The vertical baffle 21 may be situated between and substantially parallel to the demisters 24 of adjacent contacting modules 20.

According to FIG. 2, liquid downcomer 22 has an inlet 32 in an upper portion and an outlet 34 having one or more outlet openings in a lower portion. Two sloped liquid downcomer walls 30 taper the liquid downcomer 22 in the downward direction. The bottom of the substantially V-shaped liquid downcomer 22 near outlet 34 may be pointed, curved, or flat as shown in FIG. 2. Alternative embodiments having liquid downcomers of various different shapes, such as stepped or sloped and stepped, are possible. In further embodiments the cross sectional shape of the liquid downcomer may be rectangular (e.g., square), or it may be curved, irregular, or otherwise configured to define a desired co-current flow channel and geometry for delivering liquid thereto. A V-shaped liquid downcomer, as shown, provides a combination of a large contacting volume between the demisters 24 and liquid downcomer walls 30 in the lower portion of each stage 12 and a large liquid downcomer inlet 32 in the upper portion for accommodating enlarged ducts 28 and increasing liquid handling capability.

The liquid downcomer outlet 34 generally has a plurality of slots, perforations, or other types of openings arranged in one or more rows near the bottom of the liquid downcomer 22. The liquid downcomer openings may be located in the walls 30 and/or the bottom of the liquid downcomer. In operation, a liquid level 25, as shown in FIGS. 5-8, in the liquid downcomer 22 provides a seal to prevent the ascending vapor from entering the liquid downcomer through the outlets 34. The openings of liquid downcomer outlet 34 are preferably distributed along the length of the liquid downcomer 22 and they may be arranged such that the openings are varied in size or number or eliminated in the portions of the liquid downcomer 22 that are above an inferior liquid downcomer, to help prevent liquid from flowing directly from one liquid downcomer into an inferior liquid downcomer.

Demisters 24 generally run substantially along the length of liquid downcomer 22 in rows on either side. Rows of demisters 24 may be assembled from a plurality of individual demister units 40 that include male and female end plates to form seals between the units and substantially prevent fluid leakage through the junction. Other ways to join units of demister rows include the use of suitable fasteners such as bolts, clips, pins, clamps, or bands. Mechanisms such as a male and female tab and slot combination can provide advantages for quick assembly and disassembly. Welding or gluing is also possible. The modular configuration of the demisters 24 allows a fabricator to produce demister units in one or a small number of standard sizes to be assembled into demister rows 24 of varying length. Some custom-sized demister units may be required for particularly short demister rows 24 or to match the length of a liquid downcomer 22 depending on the dimensions of the apparatus and the variety of standard size demister units available. The modular design has the further advantage of easing the assembly of the contacting module 20 since the demister units are lighter than an entire row of demisters formed of a single unit. However, according to some embodiments, a single demister unit can also be the complete demister 24.

Demisters 24 are used to de-entrain liquid droplets from a vapor stream. One example is a mist eliminator, such as a vane type demister having various channels and louvers such that the fluid stream passing through the demister must undergo several changes in direction, forcing entrained liquid droplets to impact portions of the separation structure and flow downward to the bottom of the demister. Examples separation structures for demisters (or vapor-liquid separation devices) are mesh pads or woven threads. Combinations of these structures can also be used. Many possible variations in the design of the separating structures in demister units 40 are possible, the important consideration being the effectiveness of these structures in separating entrained liquid from a flowing vapor stream. This effectiveness is thought to correlate with the number of obstructions in the fluid flow which cause liquid droplets to impact a solid surface. Structures having numerous dead ends may lead to the formation of relatively quiescent regions, also promoting liquid separation.

As shown in FIG. 2, various optional elements may cooperate with and/or be incorporated into the demister 24 to further improve the performance and/or structural integrity of the overall apparatus. For example, a perforated inlet plate 42 as an inlet surface, a perforated outlet plate 44 as an outlet surface, and an imperforate top plate 45 are shown. Perforated plates are one type of flow manipulator that may cooperate with the demister 24. Other non-limiting examples of flow manipulators for demister 24 include expanded metal, porous solids, mesh pads, screens, grids, mesh, profile wire screens, and honeycombs. It has been found that the fractional open area of the flow manipulators affect both separation efficiency and pressure drop of the demister 24. The fractional open area of the flow manipulators may vary on different sides and on the same side of the demister to optimize the separation efficiency and pressure drop of the demister 24. Various types of flow manipulators may be used in a single demister. In other embodiments, flow manipulators are not used on some or any of the inlet and outlet surfaces of the demister.

The perforated inlet plate or other flow manipulator at inlet surface 42 is proximate the liquid downcomer 22. The perforated outlet plate 44 extends also the majority of the demister side opposite the perforated inlet surface 42 and along the bottom of the demister unit 40. The imperforate top plate 45 prevents liquid from leaving the demister unit 40 directly from the top and increases the vapor-liquid separation efficiency. The imperforate top plate 45 has bent strips on both sides, one following liquid downcomer wall 30 for attaching with the wall and the other following the perforated outlet plate 44 of the demister 40 for connecting with the perforated outlet plate 44. It has been found that the imperforate strip extending down a distance from the top of the perforated outlet plate 44 also improves vapor-liquid separation efficiency. The strip typically extends to cover from about 5% to about 30%, and generally from about 10% to about 20%, of the height of the demister outlet.

The plurality of ducts 28 extend through the receiving pan 26 into the liquid downcomer inlet 32. Each of the ducts 28 that extends through a particular receiving pan 26 directs liquid into a different inferior liquid downcomer 22, as is best shown in FIG. 3. As shown in this representative embodiment, the top of the duct 28 is flush with the horizontal surface 50 of the receiving pan 26 so that liquid may flow freely from the receiving pan 26 into the duct 28 without any obstruction. In other embodiments the ducts may hang from the receiving pan by having a lip that rests on the flat base 50 of the receiving pan when the ducts are fitted through the openings. The ducts may also be mounted to the underside surface of the receiving pans. Any conventional means of connecting the ducts and receiving pans may be used including but not limited to hanging, bolting, welding, and pressure fitting. Gaskets and/or sealants may be used to prevent leakage between the receiving pans and the ducts. In other embodiments the ducts may be at least partially defined by the portion of the flat base of the receiving pan that may be cut and folded or pushed out when the openings are formed. Further, the top mouth of the duct 28 may be enlarged and wider than liquid downcomer inlet 32 as shown in FIG. 2 to increase liquid handling capability and reduce choking tendency at the duct inlet. The sidewalls of the ducts 28 are sloped so that the ducts 28 fit within the liquid downcomers 22 and leave a gap for easy installation and vapor venting, as shown in FIG. 2.

Vapor may enter into liquid downcomer 22 with liquid flow from a superior stage or through liquid downcomer outlet 34 when one or more of its openings is not completely sealed by a liquid level 25 in liquid downcomer 22. If vapor in the liquid downcomer 22 is not properly vented from its inlet 32, it will be forced into ducts 28, which may choke the liquid flow through the ducts and cause severe entrainment and premature flooding of the apparatus. Therefore, it is generally beneficial to vent the vapor in liquid downcomer 22 through gaps between ducts 28 and liquid downcomer 22 or openings at the top of the liquid downcomer 22 between ducts 28. The bottom of duct 28 is opened with one or more openings, for example a plurality of spouts or one continuous slot or single larger opening to allow liquid to flow into the liquid downcomer 22. Under normal operating conditions, ducts 28 are sealed against vapor flow either dynamically by liquid in the ducts 28 or statically by liquid in the liquid downcomer 22.

The volume between inlet surface 42 of demister 24 and the adjacent wall 30 of the liquid downcomer 22 forms a fluid contacting volume or co-current flow channel 56, shown in FIG. 2. After co-current flows of vapor and liquid are contacted in co-current flow channel 56, fluid contacting continues in demister units 40 before vapor and liquid are separated. A perforated plate or other flow manipulator at inlet surface 42 of demister 24 improves fluid flow distribution through demister 24 and improves vapor-liquid separation. A flow manipulator at inlet surface 42 may also improve fluid contacting and mass transfer. The volume above receiving pan 26 and between demister rows 24 that it supports defines fluid transfer volume 58. The rows of demisters 24 may be oriented at an angle from vertical as illustrated in FIG. 2 to provide improved geometries of co-current flow channel 56, having a decreasing volume from bottom to top (to match decreasing vapor flow in this volume) and fluid transfer volume 58, having an increasing volume from bottom to top (to match increasing vapor flow in this volume).

The fluid flows through a contacting module 20 of an intermediate stage 12 include liquid flow from a superior stage that is directed into the liquid downcomer 22 by several receiving pans 26 of a superior stage, in cooperation with ducts 28 of this superior stage. The liquid, which forms liquid level 25, exits the liquid downcomer 22 through outlet 34 and enters the co-current flow channel 56. The upward vapor velocity is sufficient in co-current flow channel 56 to entrain the entering liquid. The entrained liquid is carried upward by the rising vapor to the inlet surfaces 42 of the demister units 40. The vapor and liquid are separated by the separating structures, as discussed above, within demister units 40, such that the separated vapor exits demister units 40 predominantly through the outlet surface 44 into fluid transfer volume 58. The separated vapor then continues upward to a co-current flow channel 56 of a superior contacting stage 12. The separated liquid exits the demister units 40 through the bottom portion of outlet surface 44 and flows onto the receiving pan 26. The receiving pan 26 then directs the separated liquid into the plurality of ducts 28, each of which ducts 28 of a given receiving pan direct the liquid into a different inferior liquid downcomer 22.

According to other embodiments, in lieu of perforated inlet plates 42, a porous blanket layer such as mesh pad may be used to cover the inlet to the demister units 40. The use of this porous blanket has been found to improve vapor-liquid separation, especially during operation at higher vapor rates. The porous blanket can be of conventional mesh material used for liquid droplet de-entrainment or so called “mist eliminators.” It will typically comprise very loosely woven strands forming a high surface area, low pressure drop blanket. The mesh blanket is for fine droplet coalescence and liquid distribution to the separator. An alternative construction involves mounting the mesh in an indentation in a separation structure inside a demister unit 40.

Aspects of the present invention are directed to further improvements in both vapor and liquid flow distribution in apparatuses comprising contacting stages such as those described above. Particular contacting stages of interest are those in which a pair of co-current flow channels for vapor and liquid contacting and mass transfer is formed by a liquid downcomer extending between demisters. In such contacting stages, liquid introduction or discharge from the downcomer into each co-current flow channel is necessarily from only one side of the channel. Therefore, the vapor:liquid ratio tends to be higher on the side of liquid introduction, relative to that on the opposite side. This non-uniformity of flow can, in some cases, reduce mass transfer efficiency, with the non-uniformity becoming more pronounced with increasing co-current flow channel width or volume and increasing vapor:liquid flow ratio (i.e., relatively higher vapor flow rates). FIG. 5 illustrates this non-uniformity, in which rising vapor flow 5 interacts with liquid exiting outlet 34 such that entrained liquid flow 6 in co-current flow channel 56 is directed mainly toward downcomer 22. Vapor flow 5 rises predominantly on the opposite side of co-current flow channel 56, near demister 24.

FIG. 5 therefore depicts the potential for maldistribution of both liquid and vapor flows, and particularly through a co-current flow channel 56 of a contacting module, with this channel 56 being defined by a liquid downcomer and the inlet surface 42 of a demister 24. However, it can be appreciated that non-uniform liquid flow is in general a greater contributor to overall flow maldistribution than non-uniform vapor flow, since it is the liquid that is initially discharged into the co-current flow channel in a non-uniform manner. Therefore, effectively addressing liquid maldistribution alone is generally sufficient to significantly improve the local variations in the vapor:liquid flow ratio discussed above.

Advantageously, is has been determined that the use of a liquid distribution device, or a combination of devices, proximate outlet 34 of downcomer 22 is effective in reducing the variance in the steady state, local vapor:liquid ratio (e.g., volume ratio) over a horizontal cross section of co-current flow channel 56, and particularly the horizontal (e.g., rectangular or circular) cross section near outlet 34 of liquid downcomer 22, where vapor and liquid are first contacted at a particular stage in a co-current manner. According to some embodiments, the liquid distribution device extends (e.g., horizontally or substantially horizontally) across a vapor inlet to the co-current flow channel 56, with this vapor inlet being generally proximate outlet 34 of liquid downcomer 22. The liquid distribution device may therefore extend at a horizontal position across the co-current flow channel that coincides with outlet 34 of liquid downcomer 22.

In another embodiment, the liquid distribution device can extend at a lower horizontal position within the apparatus, namely across the inlet of (e.g., on top of) a liquid downcomer of the immediately inferior stage, relative to that of the co-current flow channel 56. In this case, the liquid distribution device will extend across portions of the liquid downcomer inlet that are not engaged or occupied by ducts from the immediately superior contacting stage. Thus, the liquid distribution device can be positioned in vertical alignment with outlet 34 of liquid downcomer 22 in areas not traversed by ducts 28. This helps prevent the shortcut of liquid flow from a superior liquid downcomer to the inferior liquid downcomer without contacting vapor. Regardless of whether it is positioned in the same contacting module as the co-current flow channels or vertically aligned in an inferior contacting, the liquid distribution will preferably not significantly decrease the cross-sectional area for vapor flow, while still promoting liquid entrainment and improving flow distribution of the liquid, and in some cases both the vapor and liquid.

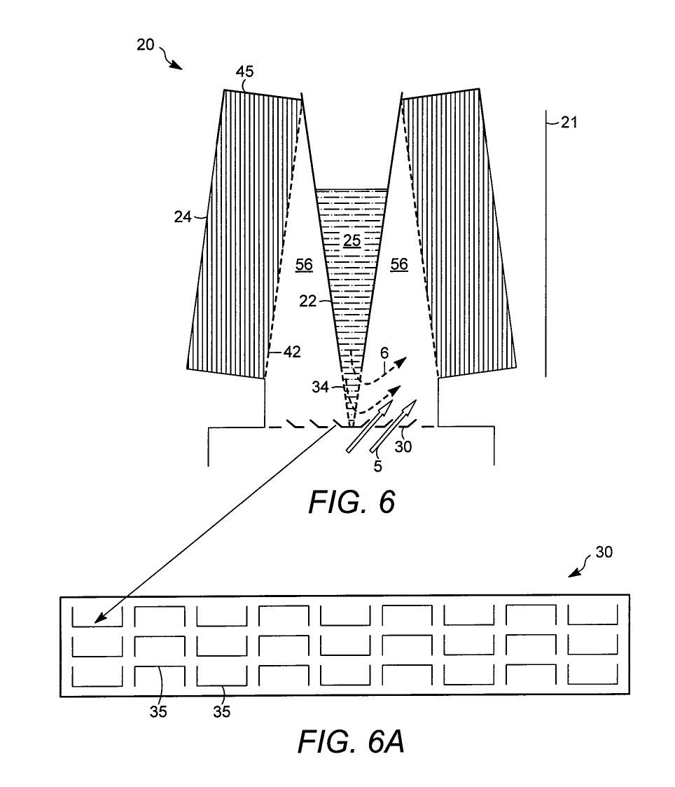

FIGS. 6, 6a, 7, 7a, 7b, 8, and 8a illustrate representative but non-limiting types of possible liquid distribution devices for use in contacting modules described herein. FIG. 6 depicts a contacting module 20 defining co-current flow channels 56 and having a liquid distribution device 30 that is a slotted plate proximate outlet 34 of liquid downcomer 22. Advantageously, the slotted plate has a plurality of slotted openings 35, at least some of which open towards, and direct upflowing vapor to, demister inlet 42. This is shown in the particular embodiment of FIG. 6a, which is a top view of the slotted plate of FIG. 6, having adjacent rows of slotted openings 35 directed in opposite directions (half toward downcomer 22 and half toward the demister inlet 42) or to opposite sides of co-current flow channel 56. The liquid distribution device 30 depicted in FIGS. 6 and 6a, namely a slotted plate, therefore affects not only the distribution of liquid discharged from outlet 34 of liquid downcomer 22, but also the distribution of vapor entering co-current flow channel 56. Other liquid distribution devices are designed to have a relatively greater impact on liquid distribution than vapor distribution due to the need, as discussed above, to address the non-uniform discharge of liquid into co-current flow channels 56, for example from only a single side of the channel. In representative slotted plates, the slotted openings 35 may be combined with other types of openings sieve holes, valves, bubble caps, which may or may not direct upflowing vapor to a side of the co-current flow channel (i.e., impart a horizontal flow component to the generally vertically flowing vapor).

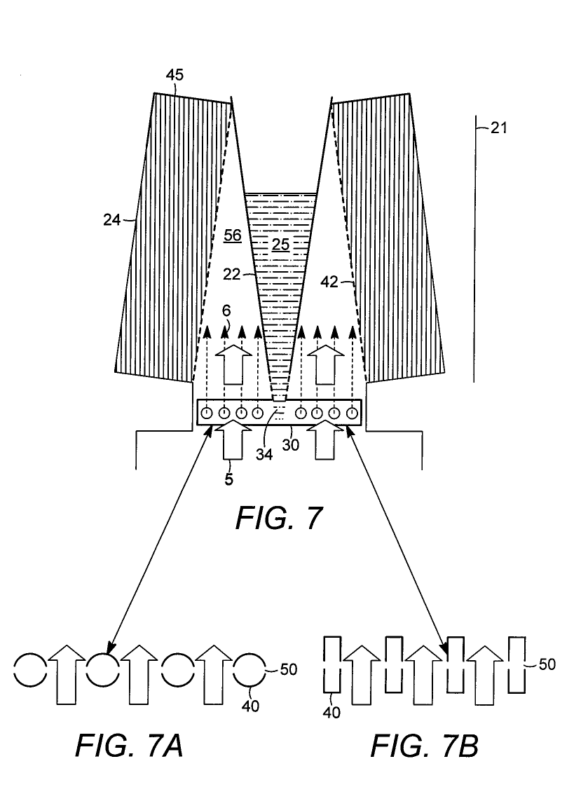

FIG. 7 shows a contacting module 20 and FIGS. 7a and 7b depict alternate views of its liquid distribution device 30, comprising a plurality of conduits 40. Liquid distribution device 30 is located proximate, and in liquid communication with, outlet 34 of liquid downcomer 22. Conduit openings or spouts 50 from conduits 40 distribute liquid from downcomer 22 uniformly across co-current flow channel 56 in areas where upflowing vapor enters the channel. The conduits may have a rectangular (e.g., square), circular, or other cross-sectional shape. Upflowing vapor 5 enters co-current flow channel 56 through areas or spaces between conduits 40 to carry liquid originating from outlet 34 of liquid downcomer 22, and then discharged through spouts 50 of conduits 40, and provide entrained liquid flow 6 in a co-current or upflowing direction. The liquid distribution device 30 depicted in FIGS. 7, 7a, and 7b therefore acts primarily to distribute liquid uniformly across a horizontal cross section of co-current flow channel, which would not be achieved in the absence of such a device.

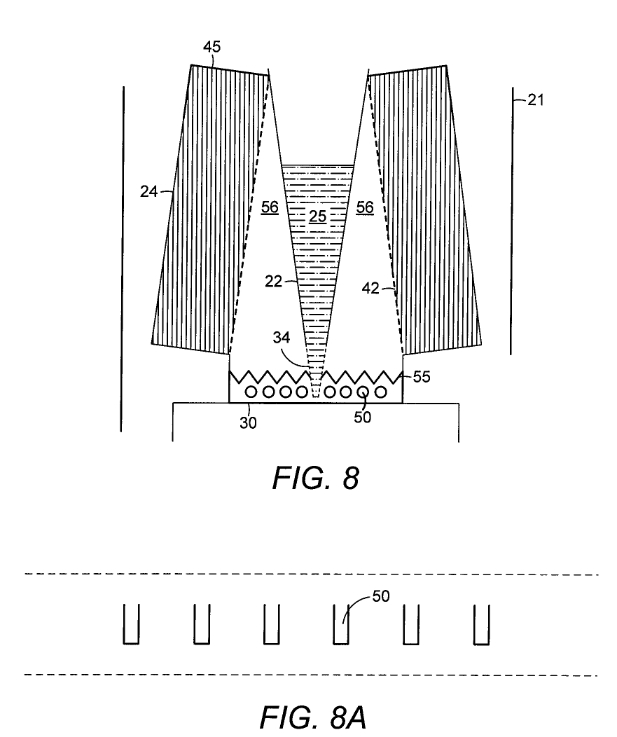

FIG. 8 shows another representative contacting module defining co-current flow channels 56. In this embodiment an open trough serves as liquid distribution device 30, with an end view of the trough provided in FIG. 8a. The trough includes notched edges 55 at its open, upper perimeter and a plurality of openings 50 located in a lower base of the trough. Again, this liquid distribution device serves to effectively distribute liquid uniformly across co-current flow channels 56.

Overall, aspects of the invention are directed to the use of liquid distribution devices in contacting modules for carrying out vapor-liquid contacting, and especially in co-current contacting modules where liquid and/or vapor are discharged into co-current flow channels in a non-uniform manner (e.g., from only one side of the channels). Those having skill in the art will recognize the advantages of the equipment and associated methods described herein and their suitability in other applications. In view of the present disclosure, it will be appreciated that other advantageous results may be obtained. Those having skill in the art, with the knowledge gained from the present disclosure, will recognize that various changes can be made in the above equipment and methods without departing from the scope of the present disclosure. Mechanisms used to explain theoretical or observed phenomena or results, shall be interpreted as illustrative only and not limiting in any way the scope of the appended claims.

1. An apparatus for performing co-current vapor-liquid contacting, comprising:
a plurality of stages having at least one contacting module, said contacting module comprising:
a) at least one liquid downcomer having an outlet proximate at least one co-current flow channel;
b) a demister having an inlet surface proximate said co-current flow channel and an outlet surface superior to a receiving pan; and
c) at least one duct having an upper end in fluid communication with said receiving pan, and a lower end, wherein said lower end of each duct is in fluid communication with a separate liquid downcomer of an inferior stage; and
d) a liquid distribution device proximate said outlet of said liquid downcomer,
wherein said contacting module is rotated with respect to a contacting module of an inferior stage of said plurality of stages.

2. The apparatus of claim 1, wherein said liquid distribution device extends across a vapor inlet to said co-current flow channel.

3. The apparatus of claim 1, wherein said liquid distribution device extends across a liquid inlet of said liquid downcomer of said inferior stage.

4. The apparatus of claim 1, wherein said liquid distribution device comprises a plate having a plurality of openings.

5. The apparatus of claim 4, wherein at least a portion of said openings are slotted openings directed toward said demister.

6. The apparatus of claim 1, wherein said liquid distribution device is in liquid communication with said outlet of said liquid downcomer and comprises a plurality of openings.

7. The apparatus of claim 6, wherein at least a portion of said openings are from conduits having a cross-section shape that is circular or rectangular.

8. The apparatus of claim 1, wherein said liquid distribution device comprises a trough having a plurality of openings.

9. The apparatus of claim 8, wherein said trough is open at an upper perimeter having a notched edge and said plurality of openings are located in a lower base of said trough.

10. The apparatus of claim 1, wherein said co-current flow channel contains a porous material.

11. A method for contacting vapor and liquid streams, the method comprising passing the streams through the co-current flow channel of the apparatus of claim 1.

12. An apparatus for performing co-current vapor-liquid contacting, comprising:
a plurality of stages, having at least one contacting module and a plurality of receiving pans, said contacting module comprising:
a) a pair of substantially parallel demisters being spaced apart;
b) a liquid downcomer located between said demisters and defining, with inlet surfaces of said demisters, a pair of co-current flow channels, wherein said inlet surfaces of said demisters are in fluid communication with said co-current flow channels, said liquid downcomer has an outlet in fluid communication with said co-current flow channels, and said demisters have outlet surfaces superior to separate receiving pans of said plurality of receiving pans; and
c) a liquid distribution device extending across vapor inlets to said pair of co-current flow channels;
wherein each receiving pan has at least one duct, with each duct of one receiving pan providing fluid communication to a separate liquid downcomer of an inferior stage; and wherein said contacting module is in non-parallel alignment with respect to the contacting module of an inferior stage of said plurality of stages.

13. The apparatus of claim 12, wherein said liquid distribution device comprises a plate having a plurality of openings.

14. The apparatus of claim 13, wherein at least a portion of said openings are slotted openings directed toward said demister.

15. The apparatus of claim 12, wherein said liquid distribution device is in fluid communication with said outlet of said liquid downcomer and comprises a plurality of openings.

16. The apparatus of claim 15, wherein at least a portion of said openings are conduits having a cross-section shape that is circular or rectangular.

17. The apparatus of claim 12, wherein said liquid distribution device comprises a trough having a plurality of openings.

18. The apparatus of claim 17, wherein said trough is open at an upper perimeter having a notched edge and said plurality of openings are located in a lower base of said trough.

19. The apparatus of claim 12, wherein said co-current flow channel contains a porous material.

20. A contacting module comprising at least one liquid downcomer having an outlet and a demister, wherein
(i) said liquid downcomer and an inlet surface of the demister define a co-current flow channel,
(ii) said outlet of said downcomer communicates with said co-current flow channel non-uniformly, and
(iii) the contacting module further comprises a liquid distribution device proximate the outlet of the liquid downcomer.
